(19) United States
(12) Patent Application Publication
(10) Pub. No.: US 2010/0221088 A1
(43) Pub. Date: Sep. 2, 2010

(54) System and Method for a Flexible Pin

(75) Inventor: Nitzan Chamiel, Jerusalem (IL)

Correspondence Address: Nitzan Chamiel, 11A Harav Tzvi Yehudah St. Apt 1, Jerusalem, 96103, IL

(73) Assignee: Nitzan Chamiel, Jerusalem (IL)

(21) Appl. No.: 12/649,411

(22) Filed: Dec. 30, 2009

Related U.S. Application Data
(60) Provisional application No. 61/142,199, filed on Jan. 1, 2009.

(51) Int. Cl. F16B 15/00; B23P 11/00

(52) U.S. Cl. 411/457; 29/525.01

(57) ABSTRACT

An autonomous flexible pin and a method is introduced for connecting a pin to a material or for connecting together materials using a single action from one side of the materials, possibly using a single hand. The preferred embodiment comprises a U-shaped pin with two sharp-pointed ends. For insertion into the material, the user's fingers are presented with a wider surface area than in the common pin. The ends are bent slightly inward to produce a spring action so that the pin would remain in place until the user will use some force to remove it, without deforming the material. Safety is enhanced relative to the common pin since when this pin is in place, the sharp ends point downwards, parallel to the fabric and slightly towards it in a limp manner.

### CROSS-REFERENCE TO RELATED APPLICATIONS

This application claims the benefit of U.S. Provisional Patent Ser. No. 61/142,199 filed Jan. 1, 2009 by the present inventor.

### FIELD OF INVENTION

This invention generally relates to connecting materials together and more particularly but not exclusively to connecting a pin to at least one material.

### BACKGROUND OF THE INVENTION

Attaching a pin to a material or to more than one material in order to connect said materials together is a common action and is especially common for people who sew materials together where a piece of material is connected using a needle or pin to another material.

Said materials may be fabric or film but other materials may also be used with this invention.

The needles and pins in use today require the user to insert the needle or pin from one side of the material and then to re-insert it from the other side of the material in order to achieve a proper connection.

The needles and pins in use today require two hands to use.

In some cases, for example where a large span of stretched fabric is the case, in order to attach a pin to it, an assistant is required to re-insert the needle or pin from the other side of the material to complete the connection.

In addition, when a common pin is in place, the sharp end points away from the fabric at some angle, and is rigid, thus posing a safety hazard.

In addition, the surface area presented to the user's finger is narrow, so that when inserting a pin into a hard material such as a plastic film the finger may bruise.

In addition, when a common pin is in place it deforms the fabric, requiring removal of the pin before performing a sewing action.

There is thus a widely recognized need for a way to place a pin from a single side of a material to form a maintained connection between materials and it would be highly advantageous to have such a method devoid of the above limitations.

### SUMMARY OF THE INVENTION

The present invention allows the user to connect an autonomous pin to a material or to connect together more than one material without the requirement to return the pin back to the first side. The pin has two pointed ends, both inserted from one side of the materials to be connected. The pin can also be used with one hand only—a convenience for any user, in particular a person who is sewing and is an important feature for a disabled person. The pin has some flexibility. As will be detailed, this flexibility is utilized to give the pin the following qualities when it is connected: the pin does not deform the materials, some force is required in order to remove the pin, and the sharp ends of the pin may point downward, adjacent to the material in a limp manner.

The preferred embodiment presents an autonomous U-shaped pin capable of being inserted using a single action from a single side of the material, performing a connection similar to that of a common pin that is inserted from one side and then re-inserted from the other side to the first side—with advantages as will be detailed. Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, the main body may be implemented by bent wire or other materials or molded material or a combination thereof.

According to one aspect of the present invention there is provided an autonomous pin device changeable from a released position to a connected position, comprising a resiliently flexible portion, on each side of which is a sharp ended member permitting to penetrate into at least one material, said sharp ended members are sloped relative to each other, said resiliently flexible portion allowing a change in said slope thus permitting said sharp ended members to be inserted into said material and settle into a maintained connected position.

According to a second aspect of the present invention there is provided a double-ended sharp pin consisting of a resiliently flexible member, extending between and mechanically interconnecting a pair of sharp penetration prongs where the angle between said prongs is less than 180 degrees.

According to a third aspect of the present invention there is provided a method of connecting a sharp-ended U-shaped spring to at least one material by applying a force pushing said spring against said material such that said sharp ends penetrate into said material creating two holes, and where the two prongs of said U-shaped spring have, rather than being parallel to each other, an angle slightly smaller than 180 degrees between them such that said force is translated into transverse forces between said material and said spring whereby as said prongs slide along said holes the said transverse forces first load said spring and then resiliently unload said spring to achieve a maintained connection between said spring and said materials.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description included with the drawings making apparent to those skilled in the art how the several forms of the invention may be embodied in practice.

In the drawings:

FIGS. 1a through 1c demonstrate the application of the autonomous flexible pin to perform a connection in 3 steps. These images also illustrate the implementation and utilization of the flexible nature of the pin.

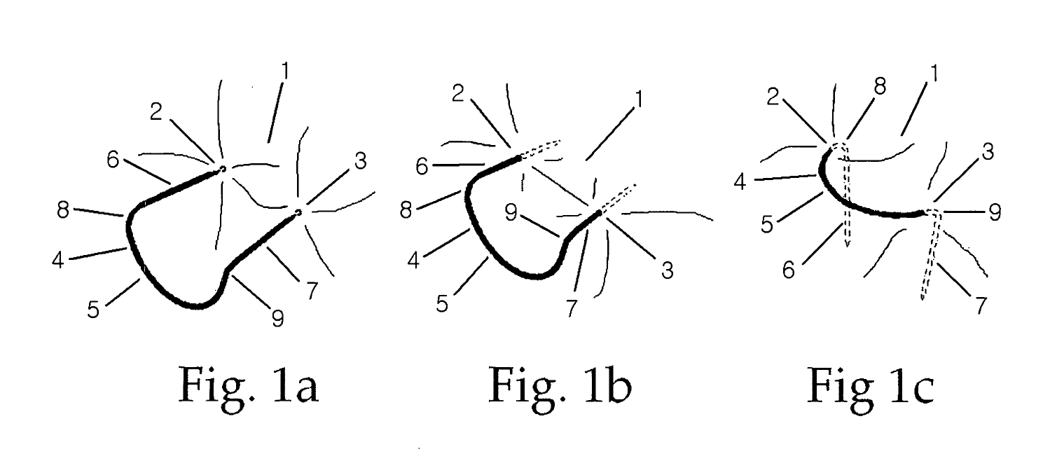

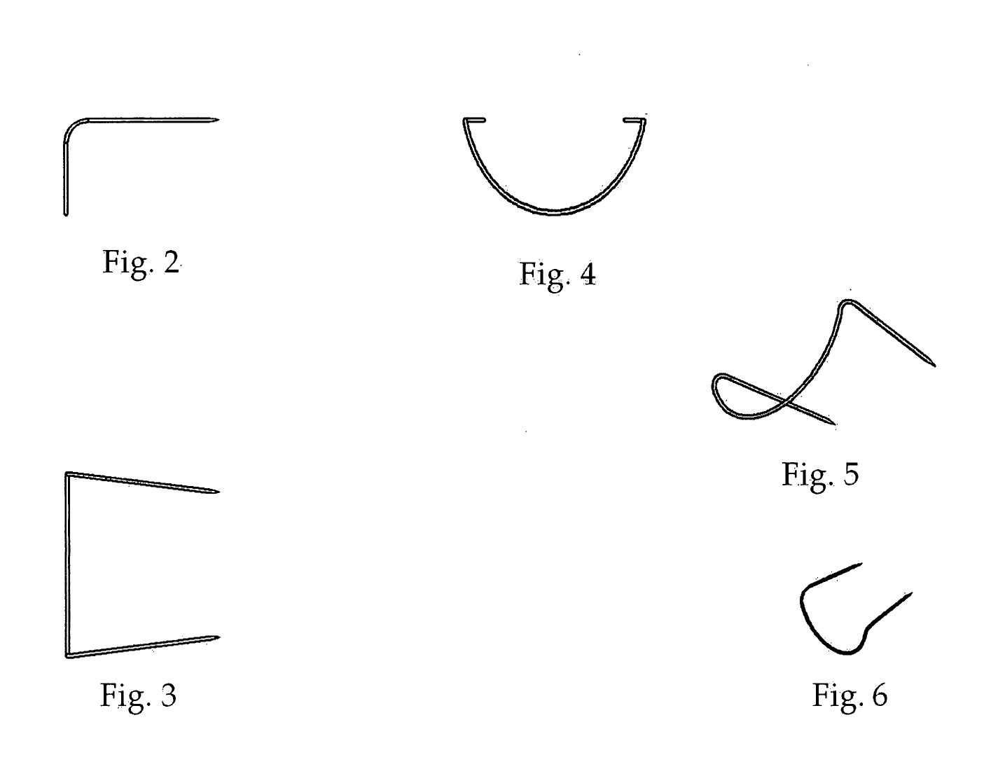

(a) FIG. 1a shows that pushing pin against the material, the pin is initially inserted into the material creating two holes.

(b) FIG. 1b shows that further insertion of the pin into the material 1 causes the prongs to ride along the holes thereby stretching the material and/or forcing the legs towards each other. Such movement is necessarily accompanied by flexure of the intermediate portion of the pin.

(c) FIG. 1c shows that final insertion of the pin into the material causes the holes to ride over the bends in the prongs. The prongs are returned to their original relative position by the resilient intermediate portion of the pin.

FIGS. 2 through 6 represent different views of the flexible pin, in accordance with an embodiment of the present invention.

FIG. 2 is a side view of a flexible pin, in accordance with an embodiment of the present invention;

FIG. 3 is a top view of a flexible pin, in accordance with an embodiment of the present invention;

FIG. 4 is a front view of a flexible pin, in accordance with an embodiment of the present invention;

FIG. 5 is a general view of a flexible pin, in accordance with an embodiment of the present invention;

FIG. 6 is a half-scale general view of a flexible pin, in accordance with an embodiment of the present invention;

It will be appreciated that, for simplicity and clarity of illustration, elements shown in the figures have not necessarily been drawn to scale. For example, the sizes of some of the elements may be exaggerated relative to other elements for clarity. Furthermore, where considered appropriate, reference numerals may be repeated among the figures to indicate corresponding or analogous elements.

### DESCRIPTION OF THE PREFERRED EMBODIMENTS

The preferred embodiments teach of an autonomous flexible pin performing a connection by insertion from one side of at least one material. Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present invention includes several embodiments that can be realized using the flexible pin described herein. In this disclosure, a pin for insertion from one side for connecting to a material or to connect together materials is described, where the pin, which has two pointed ends, is inserted from one side of at least one material. The pin for insertion comprises a substance which may be molded or formed from a metal or any material which is bent in specific manner in order to achieve the capability of connecting to at least one material.

The following are basic traits of the flexible pin:

(a) The pin may be created from a wire by bending, or molded directly into its shape.

(b) Both ends of the wire are sharp, and the general shape of the wire is in the shape of the letter U, allowing both sharp ends to be inserted through a material at the same time, and from the same side of the material.

(c) The pin is narrower near its sharp ends. This feature causes a spring action which is explained using FIGS. 1a through 1c.

(d) Both sharp ends of the pin are further bent by 90 degrees. This feature points the sharp ends downward after the pin has been inserted for safety.

(e) The pointed ends of the pin are of similar geometry as is known by those skilled in the art of the present embodiment, such as the common sewing pin, and shall not be elaborated on in this account.

Reference is now made to FIGS. 1a through 1c which demonstrate the application and implementation of the pin in 3 steps into a fabric as an example, and illustrate the implementation of the flexible trait of the pin, in accordance with an embodiment of the present invention of a bended or molded material.

In the preferred embodiment illustrated in these drawings the pin is made from a thin wire material that is flexible by nature. In other possible embodiments the flexibility trait of the pin may be implemented in a different method, for example using a mechanical structure such as a spring.

The pin has two states: released position where the pin is not connected to any material, and connected position where the pin is connected to at least one material. If the pin is connected to more than one material—these materials are held together by the pin.

The pin may change from one state to the other by the user or by any other external means that pushes the pin into at least one material or pulls said pin out from said material.

Reference is now made to the parts of the pin as shown in FIG. 1a. The pin 4 is comprised of a central portion 5 that has some flexibility. This portion is resiliently flexible such that when force acting on it is released, the portion will assume its primary shape. On either side of said central flexible portion 5, beyond bends 8 and 9, are prongs or sharp ended members 6 and 7 that are used to penetrate into a material 1 creating holes 2 and 3 in it.

In FIG. 1a the pin is not connected to the material and is in its released position. In order to insert the pin into the material, the pin is pushed against the material such that the prongs penetrate into the material, creating said two holes with the example distance of 15.9 mm between them. For the effect of pushing the pin through a relatively hard material such as a plastic film, the present invention presents a wide surface area for the fingers of the user along said central portion, in accordance with an embodiment of the present invention of a bended or molded material.

In FIG. 1b pin 4 and material 1 are shown where the prongs 6 and 7 of the pin have partially penetrated the material through holes 2 and 3 and have advanced into the material. The parts of the prongs that have penetrated the material are shown in dashed lines to indicate that they are behind the fabric. The two prongs are not parallel to each other, but rather the angle between them is slightly smaller than 180 degrees in the preferred embodiment. As the pin is advanced further into the material the pushing force creates transverse forces that stretch the material. The flexibility of the central portion allows a change in the distance between the prongs as they ride along the holes. Such movement is necessarily accompanied by flexure of the central portion, in accordance with an embodiment of the present invention of a bended or molded material.

In FIG. 1c pin 4 and material 1 are shown where the pin prongs 6 and 7 have completely penetrated the material through holes 2 and 3 beyond the bends 8 and 9. The parts of the prongs that have penetrated the material are shown in dashed lines. During final insertion of the pin into the material the prongs ride along the holes beyond the bends. The prongs are now free to return to their original relative position by the resilient central portion 5. The holes settle along the central portion above the bends at some place where the width of the pin is again 15.9 mm in this example. No stretching force now acts on the material, in accordance with an embodiment of the present invention of a bended or molded material.

As a result, for the pin to be removed from connected position, a force needs to be applied to overcome the resistance of the flexible central portion so as to allow the distance between the prongs to change so that the prongs will ride back out through the holes. Therefore the pin will be removed only when the user or any other external force pulls the pin out using some force, in accordance with an embodiment of the present invention of a bended or molded material.

For enhanced safety, when the pin is in connected position, the sharp ends of the pin point downwards in the current embodiment, parallel to the material in a limp manner, in accordance with an embodiment of the present invention of a bended or molded material.

An alternate way to describe the connection process is to regard the pin as a U-shaped spring. When the user applies force pushing this spring against a material the sharp ends of the spring penetrate into the material creating two holes. Since the prongs of the spring are not parallel but rather have an angle slightly smaller than 180 degrees between them, the said force is translated into transverse forces between the material and the spring such that as the two prongs are guided along the holes into the material the spring is first loaded and subsequently resiliently unloaded to achieve a maintained connection.

Reference is now made to the drawings depicted by FIGS. 2 through 6, which is an illustration of an autonomous flexible pin, in accordance with an embodiment of the present invention. This is an illustration of a specific embodiment according to which portrayed shape the pin may be molded directly from a variety of substances, or bent into from a substance such as a steel wire of the original length of 60 mm, a thickness of 0.4 mm, and two sharp-pointed ends. For simplicity, only production using the bending method is described herein:

(a) Step 1: bend the wire at its center into the shape of the letter U with a radius of 10.4 mm.

(b) Step 2: setting the part on a flat surface, measure 17.3 mm from the ends of the part and bend both pointed ends by 90 degrees away from the flat surface with a curvature radius of 2.3 mm.

(c) Step 3: about the same bend axis from step 2, bend both pointed ends slightly towards each other so that the distance between the two sharp-pointed ends will be 15.9 mm.

Reference is now made to FIG. 2, which is a side view of a flexible pin, in accordance with an embodiment of the present invention comprising of a bended or molded material. This image depicts a vertical 0.4 mm (typical) thick wire with a length of 10.8 mm, curving at the top to the right direction for an additional length of 17.3 mm with a curve radius of 2.3 mm. In this view both pointed ends of the pin overlap. The outcome of bending both sharp ends of the pin in this manner is that after the pin is inserted into the material, both sharp ends point downward in a manner that is advantages for safety considerations.

Reference is now made to FIG. 3, which is a top view of a flexible pin, in accordance with an embodiment of the present invention comprising of a bended or molded material. This image depicts a vertical 0.4 mm (typical) thick wire with a length of 20.4 mm, curving at the top and at the bottom to the right direction for an additional length of 17.3 mm. Both curve angles are similar and smaller than 90 degrees such that the ends of the wire, which are sharp-pointed, are 15.9 mm apart. This feature provides the flexibility trait of the pin. When the pin is initially inserted into the material, it creates 2 holes that are 15.9 mm apart. As the pin is further inserted into the material, the wider part of the pin rides along the holes in the material of the pin asserting a transverse force that stretches the material and/or elastically narrows the pin. When the pin is fully inserted, once again a narrow part of the pin is presented to the material and thus the force is resiliently withdrawn. The result is that the material is not stretched and yet the pin stays in place since removal of the pin requires the implementation of some force in order to perform the above process in reverse.

Reference is now made to FIG. 4, which is a front view of a flexible pin, in accordance with an embodiment of the present invention comprising of a bended or molded material. This image depicts a 0.4 mm (typical) thick wire shaped as half a circle opening to the top, with a radius of 10.4 mm as reference. This half-circle ends at both sides prematurely with 20 degree angles to the vertical axis. In addition, at both ends of the half-circle is depicted an inwardly bend 2.25 mm long. This half-circle gives the pin its elasticity.

Reference is now made to FIG. 5, which is a general view of a flexible pin, in accordance with an embodiment of the present invention comprising of a bended or molded material. This three-dimensional view from behind and below the pin is constructed from the 2-D views of FIGS. 2, 3 and 4.

Reference is now made to FIG. 6, which is half-scale general view of a flexible pin, in accordance with an embodiment of the present invention of a bended or molded material. This three-dimensional view from behind and above the pin is constructed from the 2-D views of FIGS. 2, 3 and 4.

In another embodiment of the present invention said ends of the pin are not sharp but rather the material to be connected already has holes in it. Examples of uses are to make the pin safer, or a kit that contains pins and a mesh material for connection. In another embodiment of the present invention a pin may be made so that it may only be inserted but not removed from the material. This may be implemented by altering the flexible nature of the pin, by altering the pin after insertion, or by addition of a locking or one-way mechanism. In another embodiment of the present invention a decoration or any other utility may include the capabilities of the flexible pin to connect to one or more materials from one side. In this manner a utility such as a decoration may be inserted from one side and possibly later removed.

It may be appreciated by those skilled in the art of the present embodiments that the present embodiments have the following advantages over existing art:

(a) The present invention presents an autonomous flexible pin that requires insertion from one side of the material only, without requiring user to re-insert the pin from the other side.

(b) The present invention provides a method to connect a pin to one or more materials in one action.

(c) The present invention allows the user to connect a pin to one or more materials using just one hand.

(d) The present invention allows connecting a pin and possibly an additional material to a large material where there is no access to the other side of the large material.

(e) The present invention allows connecting a pin and possibly an additional material to a large material where for existing art an additional person may be required to assist from the other side of the large material.

(f) When in connected position, the present invention causes less deformation of the connected materials than existing art, allowing in some cases to proceed in work such as sewing, while the pin is still connecting the materials.

(g) The present invention uses a spring action for staying in place, such that the pin will be removed only when the pin is pulled out by the user or any other external force.

(h) For the effect of pushing the pin through a relatively hard material such as a plastic film, the present invention presents more surface area for the fingers of the user.

(i) The present invention has enhanced safety since, when in connected position, the pin's sharp ends point downwards, parallel to the material and slightly pointing towards the material in a limp manner.

### CONCLUSION, RAMIFICATIONS AND SCOPE

Accordingly, the reader will see that the, closure of this invention provides a method to connect a pin to at least one material, connecting any such materials together by insertion of an autonomous flexible pin in one action from just one side said materials. The single action and the lack of the need to push the pin back through the material saves a great deal of time and work, especially for a large span of material where access to the other side is either limited or requires an assistant to push the pin from the other side of the material back to the original side in order to hold the materials together.

Furthermore the closure of this invention has the additional advantages in that:

(a) The pin is safer for use than the common pin, since when in connected position, the two sharp ends of the pin point downward, parallel to the material and slightly toward the material in a limp manner.

(b) The pin causes less deformation to the materials than the common pin, thus enabling in some cases to proceed with work such as sewing with the pin still holding the materials together.

(c) The pin may be connected using one hand only.

(d) The pin uses spring action so that the pin does not fall out from the materials unless the user actively pulls the pin from the materials using some force.

(e) For the effect of pushing the pin through a relatively hard material such as a plastic film, the present invention presents more surface area for the fingers of the user.

(f) Despite the added features and the elaborate description, the pin is intuitive to use.

Although the description above contains many specifications, these should not be constructed as limiting the scope of the invention but as merely providing illustrations of some exemplary embodiments of this invention.

For example, different materials or a mixture of materials may be used to make the pin; different sizes and different ratios may be used; a handle or an application mechanism may be added; the spring action may be altered by using a material with different shape-retaining characteristics. The angle between the two prongs may be achieved by the user applying a force that reduces the angle between the prongs. This invention may be applied for different reasons than to pin together two types of materials such as being in itself a marking point, a decoration, to tie one device to another or for any other reason. The intent of this disclosure is to cover the mechanism of the working of the pin and any use of its mechanism is covered by this disclosure.

While certain features of the invention have been illustrated and described herein, many modifications, substitutions, changes, and equivalents may now occur to those of ordinary skill in the art. It is, therefore, to be understood that the appended claims are intended to cover all such modifications and changes as fall within the true spirit of the invention.

It is expected that during the life of this patent many relevant fabric materials and materials fit for sewing needles and pins will be developed and the scope of the terms herein, particularly of the terms “material”, “pin” and “needle”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An autonomous pin device changeable from a released position to a connected position, comprising a resiliently flexible portion, on each side of which is a sharp ended member permitting to penetrate into at least one material, said sharp ended members are sloped relative to each other, said resiliently flexible portion allowing a change in said slope thus permitting said sharp ended members to be inserted into said material and settle into a maintained connected position.

2. The autonomous pin of claim 1, wherein said pin is also releasable from connected position to released position.

3. The autonomous pin of claim 1, wherein said slope angle between said sharp ended members is achieved by the user applying a force to change the angle between said sharp ended members.

4. The autonomous pin of claim 1, wherein said ends are not sharp and said material already has holes in it.

5. The autonomous pin of claim 1, wherein said ends are bent in a manner such that when said pin is in connected position said ends point parallel to said material thereby increasing safety of said pin.

6. A double-ended sharp pin consisting of a resiliently flexible member, extending between and mechanically interconnecting a pair of sharp penetration prongs where the angle between said prongs is less than 180 degrees.

7. The double-ended sharp pin of claim 6, wherein said angle between said prongs is achieved by the user applying a force to change the angle between said prongs.

8. The double-ended sharp pin of claim 6, wherein said ends terminating said prongs are not sharp.

9. A method of connecting a sharp-ended U-shaped spring to at least one material by applying a force pushing said spring against said material such that said sharp ends penetrate into said material creating two holes, and where the two prongs of said U-shaped spring have, rather than being parallel to each other, an angle slightly smaller than 180 degrees between them such that said force is translated into transverse forces between said material and said spring whereby as said prongs slide along said holes the said transverse forces first load said spring and then resiliently unload said spring to achieve a maintained connection between said spring and said materials.

10. The method of claim 9 wherein said u-shaped spring is connected to a plurality of materials whereby a maintained connection between said materials is achieved.

11. The method of claim 9, wherein said spring is releasable from the connection to said material.

12. The method of claim 9, wherein said angle between said prongs is achieved by the user applying a force to change the angle between said prongs.

13. The method of claim 9, wherein said ends are not sharp and said material already has holes in it.

14. The method of claim 9, wherein said prongs are additionally bent such that when said spring is in a maintained connection to said material, said sharp ends point parallel to said material thereby increasing safety of said spring.
